(19) United States
(12) Patent Application Publication
(10) Pub. No.: US 2007/0200944 A1
(43) Pub. Date: Aug. 30, 2007

(54) Manufacturing method for a solid-state imaging apparatus, and the solid-state imaging apparatus

(76) Inventors: Yasuo Takeuchi, Osaka (JP); Tomoko Komatsu, Kyoto (JP); Nobukazu Teranishi, Tokyo (JP); Tomoki Masuda, Osaka (JP); Yutaka Harada, Kyoto (JP); Mituru Harada, Osaka (JP); Takashi Ohbayashi, Osaka (JP)

Correspondence Address: MCDERMOTT WILL & EMERY LLP, 600 13TH STREET, N.W., WASHINGTON, DC, 20005-3096, US

(21) Appl. No.: 11/588,419

(22) Filed: Oct. 27, 2006

(30) Foreign Application Priority Data
Oct. 28, 2005 (JP) 2005-314901

(51) Int. Cl. H04N 3/14; H04N 5/335; H04N 9/64; H04N 5/217

(52) U.S. Cl. 348/294; 348/241; 348/250

(57) ABSTRACT

A light receiving region 21 and a floating diffusion region 22 are formed apart from each other in a semiconductor substrate 20 (S11), translucent adhesive 31 is applied to an area corresponding to the light receiving region 21 on the semiconductor substrate 20 (S22), and a translucent plate 30 is attached to the semiconductor substrate 20 on which the translucent adhesive 31 has been applied (S23). In this semiconductor manufacturing process, before the translucent adhesive 31 is applied, a dam member 24 is formed on the semiconductor substrate 20 so as to prevent the translucent adhesive 31 from flowing into an area corresponding to the floating diffusion region 22 on the semiconductor substrate 20 (S18).

### BACKGROUND OF THE INVENTION

(1) Field of the Invention

The present invention relates to a manufacturing method for a solid-state imaging apparatus used in digital cameras and the like, and the solid state imaging apparatus.

(2) Description of the Related Art

In the field of solid-state imaging apparatuses, research and development into techniques for improving sensitivity of solid-state imaging apparatuses are being widely carried out. Japanese Patent Application Publication No. H2-2675 discloses a technique for improving sensitivity by reducing the parasite capacity of a floating diffusion region. Generally in a solid-state imaging apparatus, a light receiving region and the floating diffusion region are formed apart from each other in the semiconductor substrate which is covered with an organic film to protect the surface. In Japanese Patent Application Publication No. H2-2675, the part of the organic film that covers the floating diffusion region is removed. This reduces the parasite capacity of the floating diffusion region, and therefore improves the voltage conversion efficiency of the floating diffusion region, and as a result, improves the sensitivity of the solid-state imaging apparatus.

On the other hand, one package structure for a solid-state imaging apparatus that has been suggested as an alternative to a commonly-used conventional hollow structure is a direct laying structure (e.g., see Japanese Patent Application Publication No. 2000-323692). In a direct laying structure, a translucent plate is attached to a semiconductor substrate having a light receiving region and a floating diffusion region with use of a translucent adhesive. An advantage of a direct layering structure is that by selecting the translucent adhesive appropriately, the difference in refraction index between the translucent plate, the translucent adhesive, and the semiconductor substrate can be reduced. By reducing the difference in refraction index, the reflection component at the boundary between each of these parts can be reduced, and as a result, the sensitivity of the solid-state imaging apparatus increases.

In recent solid-state imaging apparatuses there is a tendency for signal charge to be increasingly lower due to the reduction of the light-receiving area per pixel. One conceivable way of dealing with this problem is to combine the structures taught by the aforementioned Japanese Patent Application Publication No. H2-2675 and Japanese Patent Application Publication No. 2000-323692 to further increase sensitivity of the solid-state imaging apparatus.

However, merely combining the structures taught by the aforementioned patent documents gives rise to a problem that when attaching the translucent plate to the semiconductor substrate, the translucent adhesive (an organic material such as epoxy resin) flows into the area corresponding to the floating diffusion region on the semiconductor substrate, thus covering the floating diffusion region. In other words, even if the part of the organic film on the semiconductor substrate that covers the floating diffusion region is removed before the translucent plate is attached, the organic material (the translucent adhesive) ends up covering the floating diffusion region after the translucent plate is attached. This means that the parasite capacity of the floating diffusion region cannot be reduced, and the sensitivity of the solid-state imaging apparatus cannot be improved.

Furthermore, ordinarily the semiconductor substrate is die-bonded to the package substrate, and electrodes disposed on the semiconductor substrate are wire-bonded to the lead terminals disposed on the package substrate. If a direct laying method is employed, the manufacturing process could conceivably be performed using either of two procedures, specifically, attaching the translucent plate before performing wire-bonding, or performing wire-bonding before attaching the translucent plate. From the viewpoint of protecting the semiconductor substrate from humidity and dust, it is preferable to use the former of the two procedures. However, the former procedure is problematic because when the translucent plate is being attached, the translucent adhesive flows to the area where the electrodes are formed and adheres to the electrodes, potentially resulting in poor contact between the electrodes and the wires.

### SUMMARY OF THE INVENTION

In view of the stated problems, the present invention has a first object of providing a manufacturing method for a solid-state imaging apparatus that employs a direct laying method for directly attaching a translucent plate and a semiconductor substrate using a translucent adhesive and also reduces the parasite capacity of a floating diffusion region, and also providing the solid-state imaging apparatus.

Furthermore, the present invention has a second object of providing a manufacturing method for a solid-state imaging apparatus that employs a direct laying method and prevents the translucent adhesive from adhering to the electrodes, and also providing the solid-state imaging apparatus.

A manufacturing method of the for a solid-state imaging apparatus of the present invention includes: a formation process of forming a light receiving region and a floating diffusion region apart from each other in a semiconductor substrate; an applying process of applying translucent adhesive to the semiconductor substrate, in an area thereon corresponding to the light receiving region; and an attachment process of attaching a translucent plate to the semiconductor substrate with use of the translucent adhesive applied in the applying process, wherein, furthermore in the formation process, a dam member is formed on the semiconductor substrate such that the translucent adhesive applied in the area corresponding to the light receiving region is prevented from flowing into an area corresponding to the floating diffusion region on the semiconductor substrate.

According to the stated structure, the dam member is formed before the translucent adhesive is applied and before the translucent plate is attached. Due to the formation of the dam member, flowing translucent adhesive can be prevented from reaching and covering the floating diffusion region. Therefore, a direct laying method for directly attaching the translucent plate and the semiconductor substrate using a translucent adhesive is employed and the parasite capacity of the floating diffusion region is reduced.

Here, in the formation process, the dam member may be formed so as to extend from a first edge of the semiconductor substrate to a second edge of the semiconductor substrate, and so as to partition the area corresponding to the light receiving region from the area corresponding to the floating diffusion region.

According to the stated structure, since the dam member extends from the first edge to the second edge, the translucent adhesive is prevented from flowing around the dam member and reaching the area corresponding to the floating diffusion region. In addition, since the dam member is relatively long in length, it is relatively strong in terms of mechanical strength.

Here, in the formation process, the dam member may be formed so as to surround the area corresponding to the floating diffusion region, without surrounding the area corresponding to the light receiving region.

According to the stated structure, since the area corresponding to the floating diffusion region is surrounded by the dam member, it can be ensured that the translucent adhesive is prevented from flowing around the dam member and reaching the area corresponding to the floating diffusion region.

Here, in the formation process, the dam member may be formed such that a height thereof is a predetermined height, and in the attachment process, the translucent plate may be attached to the semiconductor substrate by placing the translucent plate on the translucent adhesive that has been applied to the area corresponding to the light receiving region, pressing the placed translucent plate until the translucent plate contacts an upper surface of the dam member while the translucent adhesive maintains fluidity, and hardening the translucent adhesive.

It is important that the thickness of the translucent adhesive be as designed, because the thickness of the translucent adhesive affects permeability characteristics. According to the stated structure, the interval between the semiconductor substrate and the translucent plate, in other words, the thickness of the translucent adhesive, is determined by the height of the dam member. Therefore, the thickness of the translucent adhesive can be made to be as designed.

Here, a horizontal cross-section of the dam member formed in the formation process may be a rectangular shape or a tapered shape.

The stated structure strongly prevents a gap from being formed between the translucent adhesive and the dam.

Here, in the formation process, the dam member may be formed by applying a photosensitive material to the semiconductor substrate, and, using a photolithography technique with respect to the applied photosensitive material, hardening a part thereof that is to be the dam member and removing the photosensitive material other than the part thereof that is to be the dam member.

According to the stated structure, the dam member can be formed without using an etching technique. Since it is not necessary to form an etching mask, the manufacturing process can be simplified.

Here, in the formation process, the dam member may be formed by depositing an etchable material on the semiconductor substrate, and, using an etching technique with respect to the deposited etchable material, causing a part of thereof that is to be the dam member to remain on the semiconductor substrate and removing the deposited material other than the part thereof that is to be the dam member.

According to the stated structure, the selection of materials that can be used for the dam member is wider than if a photosensitive material was to be used. Note that etchable material denotes a material for which a corresponding etchant exists.

Furthermore, a manufacturing method for the solid-state imaging apparatus of the present invention includes: a formation process of forming a light receiving region in a semiconductor substrate and forming a plurality of electrodes on the semiconductor substrate, the plurality of electrodes being a part on the semiconductor substrate from an area thereon corresponding to the light receiving region; an applying process of applying translucent adhesive to the area corresponding to the light receiving region; and an attachment process of attaching a translucent plate to the semiconductor substrate with use of the translucent adhesive applied in the applying process, wherein, furthermore in the formation process, a dam member is formed on the semiconductor substrate such that the translucent adhesive applied in the area corresponding to the light receiving region is prevented from flowing to the electrodes.

According to the stated structure, the dam member is formed before the translucent adhesive is applied and before the translucent plate is attached. Due to the formation of the dam member, the flowing translucent adhesive can be prevented from reaching and adhering to the electrodes.

Here, in the formation process, the dam member may be formed in an area that is an outer peripheral area of the area corresponding to the light receiving region and an inner peripheral area of an area in which the electrodes are formed.

According to the stated structure, the translucent adhesive is prevented from flowing around the dam member and reaching the electrodes. In addition, since the dam member is relatively long in length, it is relatively strong in terms of mechanical strength.

Here, the dam member formed in the formation process may have a vent in an area other than an area between the plurality of electrodes and the area corresponding to the light receiving region.

According to the stated structure, since gas escapes through the vent when attaching the translucent plate, gaps are prevented from being formed between the translucent adhesive and the translucent plate. In addition, since the vent exists in an area that is not between the electrodes and the area corresponding to the light receiving region, any translucent adhesive that flows through the vent can be prevented from reaching the electrodes.

Furthermore, a solid-state imaging apparatus of the present invention includes: a semiconductor substrate having disposed therein a light receiving region and a floating diffusion region that are apart from each other; a translucent plate that is attached to the semiconductor substrate via translucent adhesive that has been applied to the semiconductor substrate in an area thereon corresponding to the light receiving region; and a dam member disposed on the semiconductor substrate such that the translucent adhesive applied in the area corresponding to the light receiving region is prevented from flowing into an area corresponding to the floating diffusion region on the semiconductor substrate.

According to the stated structure, if the dam member is formed before the translucent adhesive is applied and before the translucent plate is attached, a direct laying method for attaching the translucent plate and the semiconductor substrate using a translucent adhesive can be employed, while also reducing the parasite capacity of a floating diffusion region.

Here, the dam member may be made of resin that contains filler.

According to the stated structure, the dam member has a greater mechanical strength than if the resin did not contain filler.

Furthermore, a solid-state imaging apparatus of the present invention includes: a semiconductor substrate that has a light receiving region therein; a plurality of electrodes disposed on the semiconductor substrate, the plurality of electrodes being apart on the semiconductor substrate from an area thereon corresponding to the light receiving region; a translucent plate attached to the semiconductor substrate with use of translucent adhesive that has been applied to the semiconductor substrate in the area corresponding to the light receiving region; and a dam member disposed on the semiconductor substrate such that the translucent adhesive applied in the area corresponding to the light receiving region is prevented from flowing to the electrodes.

According to the stated structure, if the dam member is formed before the translucent adhesive is applied and before the translucent plate is attached, the flowing translucent adhesive can be prevented from reaching and adhering to the electrodes.

Here, the dam member may be disposed in an area that is an outer peripheral area of the area corresponding to the light receiving region and an inner peripheral area of an area in which the electrodes are formed.

According to the stated structure, the translucent adhesive is prevented from flowing around the dam member and reaching the electrodes.

Here, a fillet may be formed from the translucent adhesive at a side face of the translucent plate.

According to the stated structure, the translucent plate is more firmly attached.

Here, a horizontal cross-section of the dam member may have a rectangular shape or a tapered shape.

The stated structure strongly prevents gaps from being formed between the translucent adhesive and the dam.

Here, an upper surface of the dam member may curve in an upward convex.

The stated structure, allows for changes in shape due to heat contraction when forming the dam member, and therefore enables the dam member to be formed more easily, as well as widening the selection of materials that can be used for the dam member.

Here, the dam member may be made of organic resin.

According to the stated structure, the dam member can be easily formed on an organic film that has low heat resistance and that has been stacked in order to form a color filter, a microlens, and the like.

Here, the dam member may be made of photosensitive material.

According to the stated structure, the dam member can be formed without using an etching technique, and therefore the manufacturing process can be simplified.

Furthermore, a solid-state imaging apparatus of the present invention includes: a semiconductor substrate that has a light receiving region therein; a plurality of electrodes disposed on the semiconductor substrate, the plurality of electrodes being apart on the semiconductor substrate from and area thereon corresponding to the light receiving region; and a translucent plate attached to the semiconductor substrate via translucent adhesive that has been applied to the semiconductor substrate in the area corresponding to the light receiving region, wherein the translucent plate has a groove in a surface that is attached to the semiconductor substrate, the groove being in an area of the surface other than an area that opposes the light receiving region, and part of the translucent adhesive applied to the area corresponding to the light receiving region is received by the groove.

According to the stated structure, excess translucent adhesive is received by the groove when attaching the translucent plate to the semiconductor substrate. This enables a direct laying structure by which the translucent plate and the semiconductor substrate are attached to each other by the translucent adhesive, while also strongly preventing the flowing translucent adhesive from reaching and adhering to the electrodes.

Here, the plurality of electrodes may be disposed in a row, and the groove may extend in a direction in which the electrodes are arranged.

According to the stated structure, the translucent adhesive can be even more effectively prevented from adhering to the electrodes.

### BRIEF DESCRIPTION OF THE DRAWINGS

These and other objects, advantages and features of the invention will become apparent from the following description thereof taken in conjunction with the accompanying drawings which illustrate a specific embodiment of the invention.

In the drawings:

FIG. 1 is an exploded perspective view of a solid-state imaging apparatus of the first embodiment;

FIG. 2 is a planar view of the solid-state imaging apparatus of the first embodiment;

FIGS. 3A and 3B are a cross-sectional views of the solid-state imaging apparatus of the first embodiment;

FIG. 4 is an enlarged planar view of the semiconductor substrate 20 of the first embodiment;

FIG. 5 is a partial cross-sectional view of the semiconductor substrate 20 of the first embodiment;

FIG. 6 shows manufacturing processes for the solid-state imaging apparatus 1 of the first embodiment;

FIG. 7 shows a cross-sectional view of the solid-state imaging apparatus 1 one of the manufacturing processes;

FIG. 8 shows a cross-sectional view of the solid-state imaging apparatus 1 one of the manufacturing processes;

FIG. 9 shows a cross-sectional view of the solid-state imaging apparatus 1 one of the manufacturing processes;

FIG. 10 shows a cross-sectional view of the solid-state imaging apparatus 1 one of the manufacturing processes;

FIG. 11 shows a planar view of the solid-state imaging apparatus of the second embodiment;

FIGS. 12A and 12B are cross-sectional views of the solid-state imaging apparatus of the second embodiment;

FIG. 13 is an enlarged planar view of the semiconductor substrate 20 of the second embodiment;

FIG. 14 is a planar view of a solid-state imaging apparatus of the third embodiment;

FIGS. 15A and 15B are cross-sectional views of the solid-state imaging apparatus of the third embodiment;

FIG. 16 is an enlarged planar view of the semiconductor substrate 20 of the third embodiment;

FIG. 17 is a planar view of a solid-state imaging apparatus of the fourth embodiment;

FIG. 18 is a cross-sectional view of the solid-state imaging apparatus of the fourth embodiment;

FIG. 19 is a planar view of a solid-state imaging relating to a modification example;

FIG. 20 shows the manufacturing process of the solid-state imaging apparatus of the fourth embodiment;

FIGS. 21A to 21C are process cross-sectional views of the solid-state imaging apparatus of the fourth embodiment;

FIG. 22 is a planar view of a solid-state imaging apparatus of the fifth embodiment;

FIG. 23 is a cross-sectional view of the solid-state imaging apparatus of the fifth embodiment;

FIG. 24 is a cross-sectional view of a solid-state imaging apparatus of the sixth embodiment;

FIG. 25 is a cross-sectional view of the solid-state imaging apparatus of the seventh embodiment;

FIG. 26 is a planar view of the solid-state imaging apparatus of the eighth embodiment;

FIG. 27 is a cross-sectional view of the solid-state imaging apparatus of the eighth embodiment; and

FIG. 28 is a cross-sectional view of the translucent plate of a modification example.

### DESCRIPTION OF THE PREFERRED EMBODIMENTS

The following describes preferred embodiments of the present invention with reference to the drawings.

### First Embodiment

<Structure>

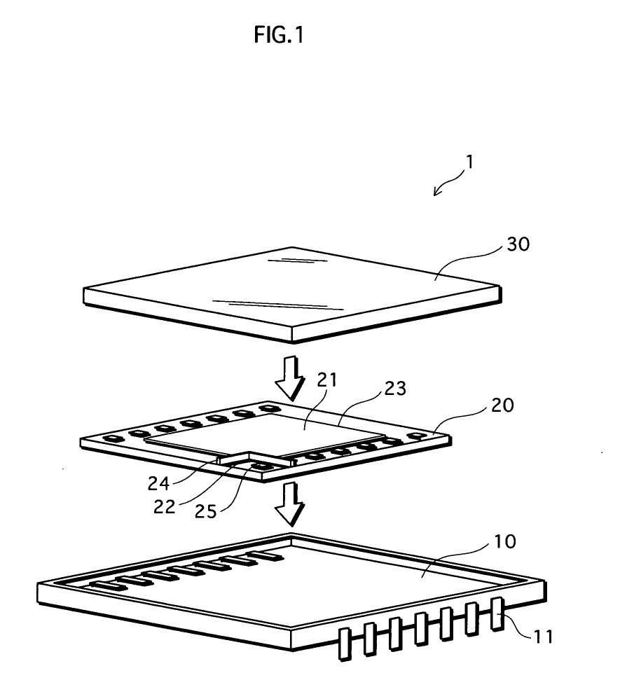

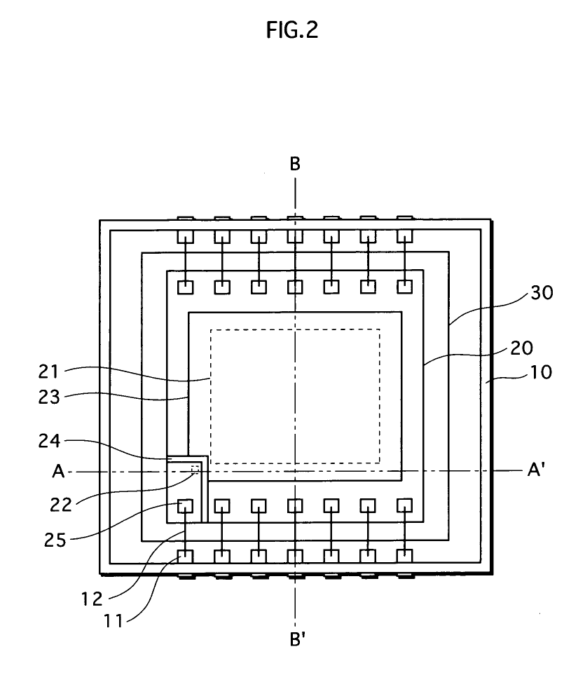

FIG. 1 is an exploded perspective view of a solid-state imaging apparatus 1 of the first embodiment, and FIG. 2 is a planar view of the solid-state imaging apparatus 1 of the first embodiment.

As shown in FIG. 1 and FIG. 2, the solid-state imaging apparatus 1 is composed of a package substrate 10, a semiconductor substrate 20, and a translucent plate 30. The package substrate 10 is made of a material such as ceramic or plastic, and has lead terminals 11. The semiconductor substrate 20 has a light receiving region 21 and a floating diffusion region 22 that is disposed apart from the light receiving region 21. The semiconductor substrate 20 is die-bonded to the package substrate 10. The translucent plate 30 is made of a non-organic material (e.g., borosilicate glass or silica glass), an organic material (e.g., acrylic resin or polycarbonate resin), or a hybrid of these materials, and is attached to the semiconductor substrate 20 by a translucent adhesive.

A dam member 24 is disposed on the semiconductor substrate 20 to prevent the translucent adhesive applied to an area corresponding to the light receiving region 21 on the semiconductor substrate 20 from flowing into an area corresponding to the floating diffusion region 22 on the semiconductor substrate 20. In the first embodiment, the dam member 24 is disposed between the area corresponding to the light receiving region 21 on the semiconductor substrate 20 and the area corresponding to the floating diffusion region 22 on the semiconductor substrate 20, and extends from a first edge of the semiconductor substrate 20 to a second edge of the semiconductor substrate 20.

Also provided on the semiconductor substrate 20 is a plurality of electrodes 25 disposed apart from the area corresponding to the light receiving region 21. The electrodes 25 are electrically connected to the lead terminals 11 by wires 12.

An organic film 23 is also formed on the semiconductor substrate 20. This organic film 23 is for protecting the surface of the semiconductor substrate 20, and a part of the organic film 23 that corresponds to the floating diffusion region 22 has been removed.

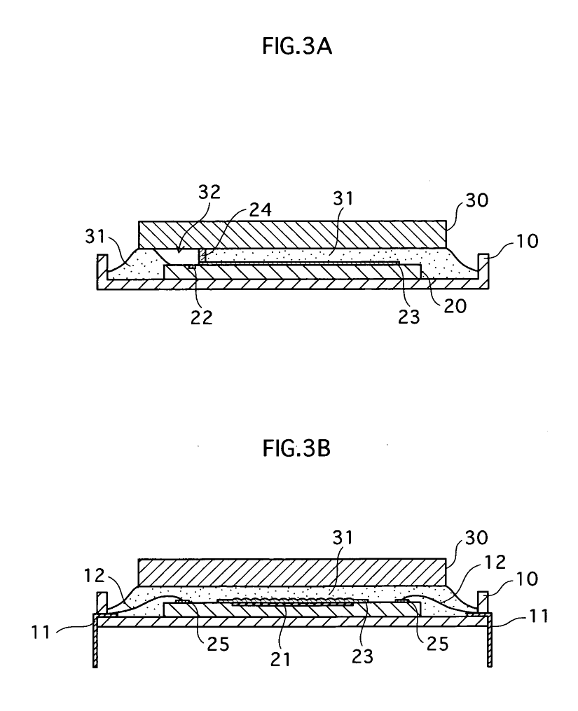

FIGS. 3A and 3B are cross-sectional views of the solid-state imaging apparatus 1 of the first embodiment.

FIG. 3A shows an A-A′ cross-section in the planar view of FIG. 2, and FIG. 3B shows a B-B′ cross-section in the planar view of FIG. 2.

The translucent plate 30 is attached to the semiconductor substrate 20 and the package substrate 10 via translucent adhesive 31. The translucent adhesive 31 is applied to the area corresponding to the light receiving region 21 on the semiconductor substrate 20, and is not applied to the area corresponding to the floating diffusion region 22 on the semiconductor substrate 20. In other words, a gap 32 is formed between the translucent plate 30 and the area corresponding to the floating diffusion region 22 on the semiconductor substrate 20, without the floating diffusion region 22 being covered with the translucent adhesive 31. In this way, since the floating diffusion region 22 is covered neither by the organic film 23 nor by the translucent adhesive 31, the parasite capacity of the floating diffusion region 22 is reduced.

Note that the translucent plate 30 contacts the upper surface of the dam member 24. The height of the dam member 24 is set such that the translucent plate 30 does not contact loops of the wires 12.

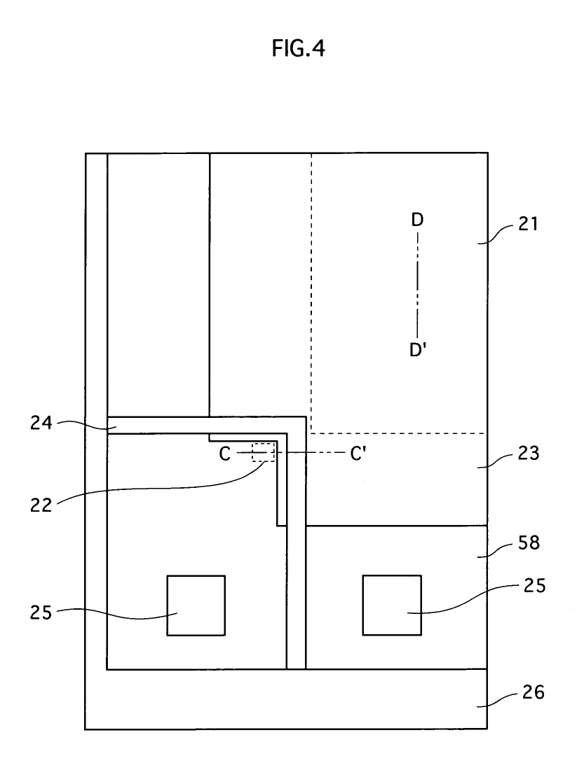

FIG. 4 is an enlarged planar view of the semiconductor substrate 20 of the first embodiment.

The semiconductor 20 has a scribe region 26, and, excluding the area of the semiconductor substrate 20 occupied by the scribe region 26, the semiconductor substrate 20 is covered by a planarized layer 58 that is made of anon-organic material. The organic film 23 covers the planarized layer 58, but the part corresponding to the floating diffusion region 22 and the parts corresponding to the electrodes 25 have been removed.

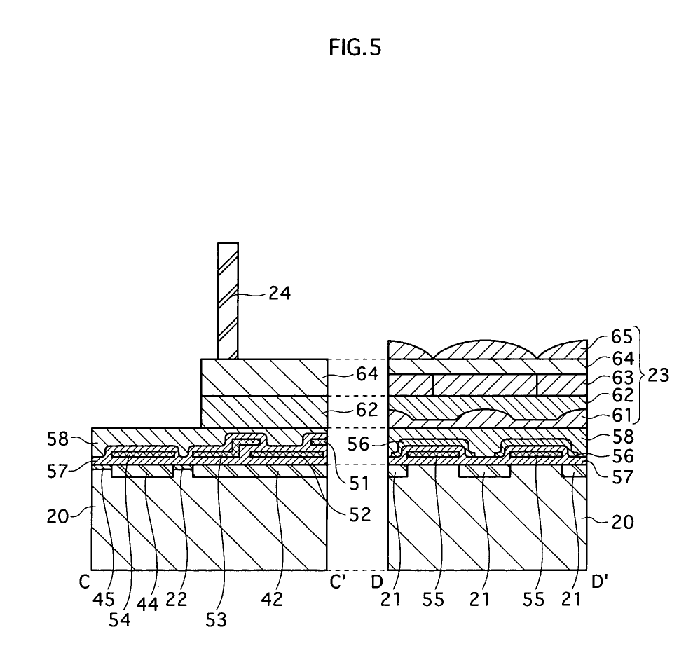

FIG. 5 is a partial cross-sectional view of the semiconductor substrate 20 of the present embodiment.

FIG. 5 shows a C-C′ cross-section and a D-D′ cross-section in the planar view in FIG. 4.

Referring to the C-C′ cross-section, the semiconductor substrate 20 has a horizontal transfer channel region 42, the floating diffusion region 22, a reset gate lower region 44 and a reset drain region 45. Formed on the semiconductor substrate 20 are a first horizontal transfer electrode 51, a second horizontal transfer electrode 52, an output gate electrode 53, and a reset gate electrode 54. These electrodes are insulated from each other by an interlayer insulating layer 57. Stacked on the interlayer insulating layer 57 is the planarized layer 58 which is made of non-organic material such as BPSG, BSG, or PSG, and stacked on the planarized layer 58 is planarized layers 62 and 64 which are made of organic material. Note that the parts of the planarized layers 62 and 64 corresponding to the floating diffusion region 22 have been removed. The dam member 24 is formed on the planarized layer 64.

Referring now to the D-D′ cross-section, it can be seen that the semiconductor substrate 20 includes the light receiving region 21, and that formed on the semiconductor substrate 20 is vertical transfer electrodes 55 which are insulated from each other by the interlayer insulating layer 57. A light blocking film 56 and the planarized layer 58 are stacked on the interlayer insulating layer 57, and stacked on the planarized layer 58 are, in the stated order, an intralayer lens layer 61, a planarized layer 62, a color filter layer 63, a planarized layer 64, and a microlens 65. These layers on the planarized layer 58 are made of organic material, and together compose the organic film 23.

<Manufacturing Method>

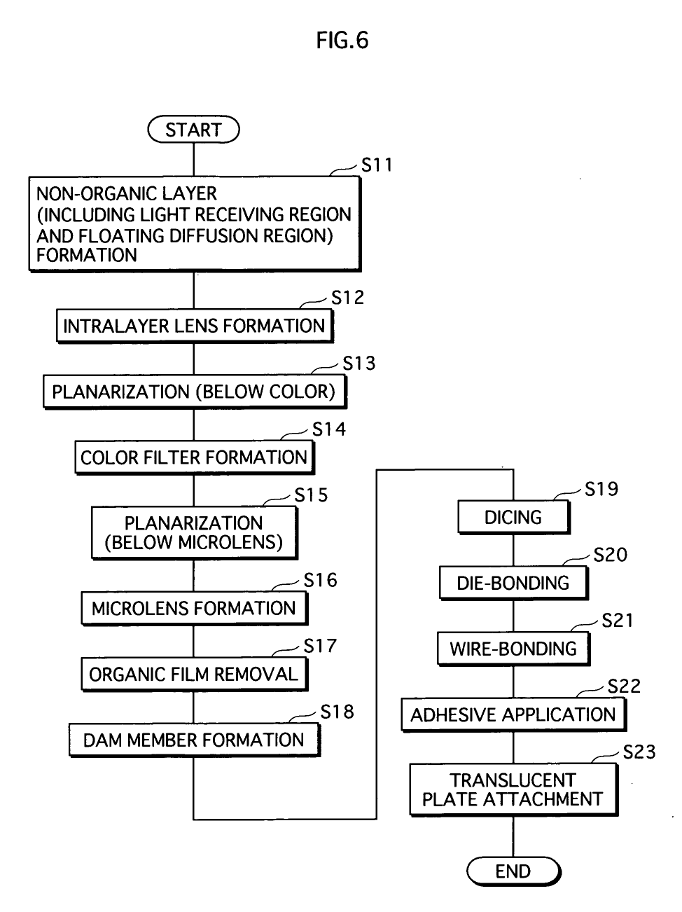

FIG. 6 shows manufacturing processes for the solid-state imaging apparatus 1 of the first embodiment.

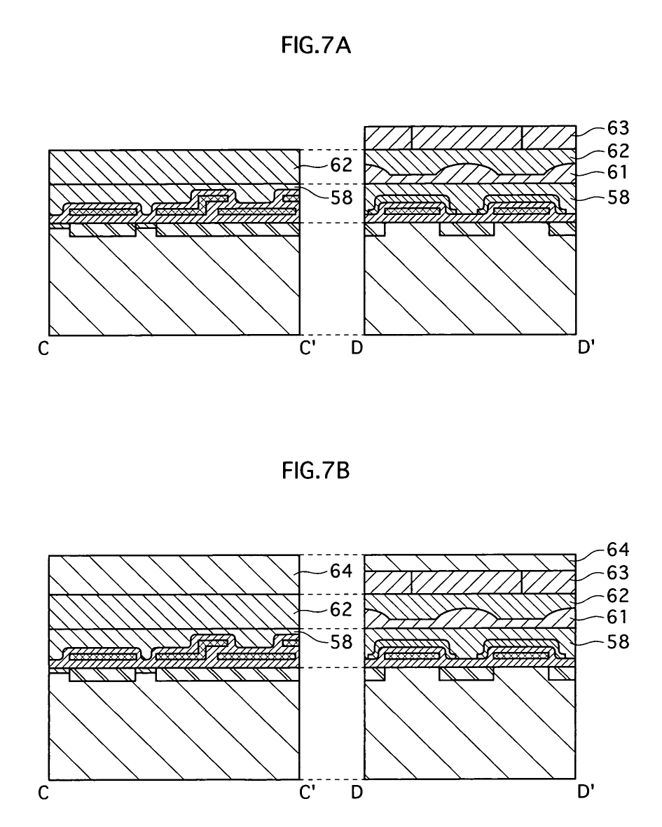

FIGS. 7 to 10 show cross-sectional views of the solid-state imaging apparatus 1 in each of the processes.

A non-organic layer including the light receiving region 21 and the floating diffusion region 22 are formed in the semiconductor substrate 20 (FIG. 6: S11). More specifically, the light receiving region 21, the floating diffusion region 22, the horizontal transfer channel region 42, the floating diffusion region 22, the reset gate lower region 44, and the reset drain region 45 are formed by adding n-type impurities to the semiconductor substrate 20. The interlayer insulation layer 57 is stacked on the semiconductor substrate 20, and the first horizontal transfer electrode 51, the second horizontal transfer electrode 52, the output gate 53, the reset gate electrode 54, the vertical transfer electrodes 55, and the light blocking film 56 are formed on the semiconductor substrate 20. Non-organic material such as BPSG, BSG or PSG is then deposited on the semiconductor substrate 20 so as to cover the entire semiconductor substrate 20, and is reflowed so as to form the planarized layer 58.

Next, the intralayer lens layer 61 is formed on the planarized layer 58 from organic material (FIG. 6: S12).

After the intralayer lens layer 61 is formed, the planarized layer 62 is formed by spin-coating organic material (FIG. 6: S13), and the color filter layer 63 made of organic material is formed on the planarized layer 62 (FIG. 6: S14, FIG. 7(a)).

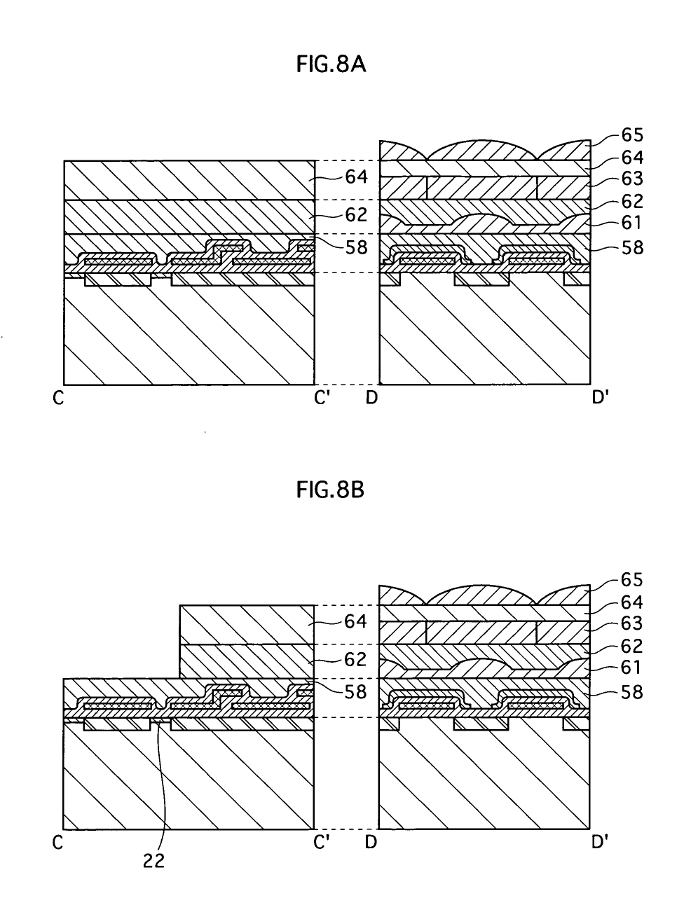

After the color filter layer 63 is formed, the planarized layer 64 is formed by spin-coating organic material (FIG. 6: S15, FIG. 7(b)), and the microlens 65 made of organic material is formed on the planarized layer 64 (FIG. 6: S16, FIG. 8(a)).

Next, the portion of the organic film corresponding to the floating diffusion region 22 is removed by etching or another technique (FIG. 6: S17, FIG. 8(b)).

After the portion of the organic film corresponding to the floating diffusion region 22 has been removed, the dam member 24 is formed (FIG. 6: S18).

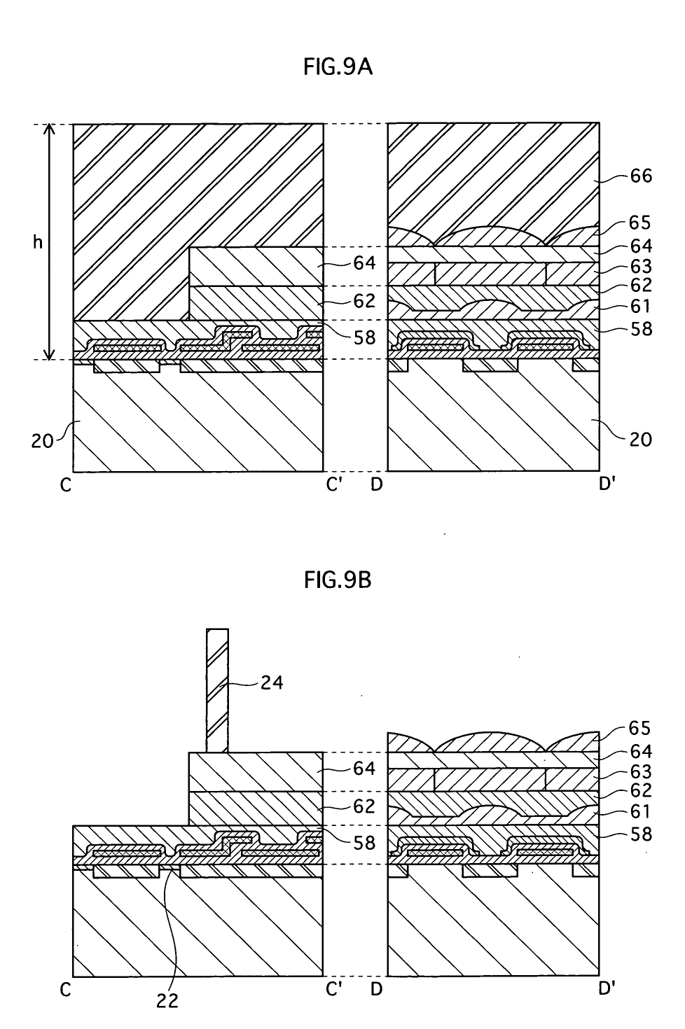

To form the dam member 24, first resin material that is to constitute the dam member 24 is spin-coated to form a resin layer 66 that covers the semiconductor substrate 20 (FIG. 9(a)).

The resin material used for the dam member 24 may be a general positive or negative photosensitive resin such as an acrylic resin, a styrene resin or a phenol novolac, or an organic resin such as a urethane resin, an epoxy resin, or a styrene resin. If the resin selected from among these resins is the same as a photosensitive resin used to form the non-organic layer or the organic film 23, or the same as an organic resin used in the organic layer 23, the number of materials used in the solid-state imaging apparatus 1 can be reduced, thus facilitating easier management of materials. Furthermore, the dam member 24 may be made of a material that contains approximately 0% to 80% of filler to binder resin. Here, the filler may be a spherical filler, a fiber filler, or an irregular filler such as a filler made from resin, a filler made from glass, or a filler made from silica. Using a resin material that contains a filler increases the mechanical strength of the dam member 24.

The thickness of the resin layer 66 is such that a height h from the upper surface of the semiconductor substrate 20 to the upper surface of the resin layer 66 is equal to the planned interval from the upper surface of the semiconductor substrate 20 to the lower surface of the translucent plate 30. If the resin layer 66 is to have a thickness of approximately 1 μm to 50 μm, it can be formed by spin-covering once. If the resin layer 66 is to be any thicker than this, spin-covering is performed a plurality of times. Using spin-covering enables the upper surface of the semiconductor substrate 20 and the upper surface of the resin layer 66 to be substantially parallel.

When the resin layer 66 has been formed, the part of the resin layer 66 that is to be the dam member 24 is left remaining, while the unnecessary part of the resin layer 66, in other words the whole of the resin layer 66 except for the part that is to be the dam member 24, is removed (FIG. 9(b)).

In the case of the dam member 24 being made of photosensitive resin, the resin layer 66 is formed using the photosensitive resin, and photolithography is used to harden the part that will be the dam member 24 as well as to remove the unnecessary part. As one example, the spinning speed in the spin-coating may be approximately 1000 rpm to 3000 rpm, the pre-bake temperature may be approximately 80° C. to 100° C., the exposure time may be approximately 100 msec to 1000 msec, and the developing fluid may be an alkaline developing fluid.

In the case of the dam member 24 being made of etchable resin, the resin layer 66 is formed using the resin, and a mask is formed thereon that covers the portion that will be the dam member 24 and is open elsewhere. Etching is then performed to leave the part that is to be the dam member 24 remaining, and remove the unnecessary part.

The processes from S11 to S18 in FIG. 4 are a so-called wafer process, and the semiconductor substrate 20 is handled in a wafer state.

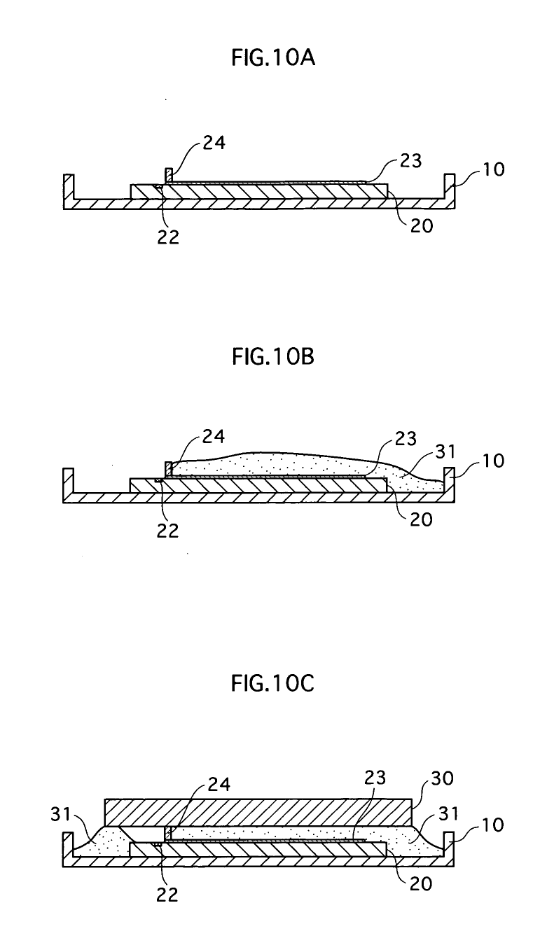

Next, the wafer is diced (FIG. 6: S19), and the diced semiconductor substrate 20 is die-bonded to the package substrate 10 (FIG. 6: S20, FIG. 10(a)).

After the die-bonding, the electrodes 25 that have been disposed on the semiconductor substrate 20 are wire-bonded to the lead terminals 11 that have been disposed on the package substrate 10 (FIG. 6: S21).

After the wire-bonding, the translucent adhesive 31 is applied to the area corresponding to the light receiving region 21 on the semiconductor substrate 20 (FIG. 6: S22, FIG. 10(b)). The translucent adhesive 31 may, for instance, be an epoxy adhesive that hardens at approximately 100° C. to 150° C., or a silicone adhesive that hardens at approximately room temperature to 150° C. Furthermore, a dispensing method may be used to apply the translucent adhesive 31. Note that translucent adhesive denotes an adhesive that is translucent after hardening.

After the adhesive has been applied, the translucent plate 30 is attached to the semiconductor substrate 20 (FIG. 6: S23, FIG. 10(c)). This is done by placing the translucent plate 30 on the semiconductor substrate 20 to which the translucent adhesive 31 has been applied, and pressing translucent plate 30 while the translucent adhesive 31 maintains fluidity, until the translucent plate 30 contacts the upper surface of the dam member 24. Either while being pressed or after being pressed, the translucent plate 30 is shifted in a horizontal direction to adjust the position, the tilt and the like in thereof in the horizontal direction. Note that from a viewpoint of resistance against humidity and dust, it is preferable that the semiconductor substrate 20 be sealed in the package substrate 10, the translucent plate 30 and the translucent adhesive 31. To achieve this, in the process of applying the translucent adhesive 31, the amount of the translucent adhesive 31 applied and the locations where the translucent adhesive 31 is applied are adjusted so that when the translucent plate 30 is attached, the translucent adhesive 31 flows around the dam member 24 to enclose the semiconductor substrate 20. Note that care should be taken so that the translucent adhesive 31 that flows around the dam member 24 does not reach the area corresponding to the floating diffusion region 22 on the semiconductor substrate 20.

Next, with the translucent plate 30 contacting the upper surface of the dam member 24, the translucent adhesive 31 is hardened.

In the first embodiment, since the dam member 24 is formed in this way, the translucent adhesive 31 applied to the area corresponding to the light receiving region 21 on the semiconductor substrate 20 is prevented from flowing into the area corresponding to the floating diffusion region 22 when attaching the translucent plate 30 to the semiconductor substrate 20. With this structure, the sensitivity of the solid-state imaging apparatus 1 can be increased by several to 10%.

Furthermore, since the translucent plate 30 is attached in a state of having being pushed until it contacts the upper surface of the case 24, the interval between the semiconductor substrate 20 and the translucent plate 30, in other words, the thickness of the translucent adhesive 31, is determined by the height of the dam member 24. Therefore, the thickness of the translucent adhesive 31 can be made to be as designed. Note that, using the upper surface of the semiconductor substrate 20 as a reference, the height of the upper surface of the dam member 24 is greater than the highest point of the microlens 65. This prevents a situation in which the translucent plate 30 crushes the microlens 65 when the translucent plate 30 is being positioned in the height direction.

In addition, since the upper surface of the dam member 24 is substantially parallel with the upper surface of the semiconductor substrate 20, the translucent plate 30 can be disposed substantially parallel with the semiconductor substrate 20 by attaching the translucent plate 30 in a state of contacting the upper surface of the dam member 24. In particular, since the dam member 24 extends from the first edge to the second edge in the first embodiment, the length of the part of the upper surface of the dam member 24 and the part of the surface of the translucent plate 30 that contact each other is relatively long. This means that the translucent plate 30 and the semiconductor substrate 20 can be disposed substantially parallel to each other with relatively high accuracy. As a result, shading that is caused if the translucent plate 30 is inclined with respect to the semiconductor substrate 20 can be prevented.

Furthermore, since the dam member 24 is formed in the wafer process, variations in the height of the dam member 24 between products can be suppressed.

Furthermore, if the dam member 24 is formed so as to be between the area corresponding to the light receiving region 21 on the semiconductor substrate and the area corresponding to the floating diffusion region 22 on the semiconductor substrate 20, the objects of the present invention can be achieved even if the position of the dam member 24 deviates to a certain extent. Therefore, a mask of a relatively low rank can be used to form the dam member 24, and the time required for positioning with a stepper can be reduced.

Furthermore, by employing a direct laying structure in which the translucent plate 30 and the semiconductor substrate 20 are directly attached via the translucent adhesive 31, the overall size of the solid-state imaging apparatus 1 can be reduced. Furthermore, deterioration in the shape, transparency and refractive index of the microlens 65 (particularly if made of organic material) that occurs due to changes in environment (humidity, in particular) can be prevented.

Note that the first embodiment is preferably used in cases in which the distance between the edge of the semiconductor substrate 20 and the edge of the package substrate 10 is greater than 250 μm.

### Second Embodiment

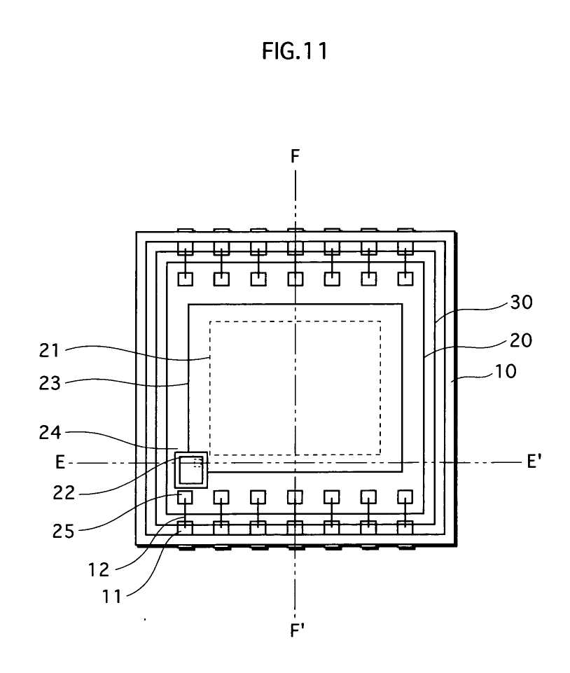

FIG. 11 shows a planar view of the solid-state imaging apparatus of the second embodiment.

In the second embodiment, the dam member 24 surrounds the area corresponding to the floating diffusion region 22 on the semiconductor substrate 20, and does not surround the electrodes 25 and the area corresponding to the light receiving region 21 on the semiconductor substrate 20. Furthermore, the package substrate 10 in the second embodiment is smaller than the package substrate 10 in the first embodiment.

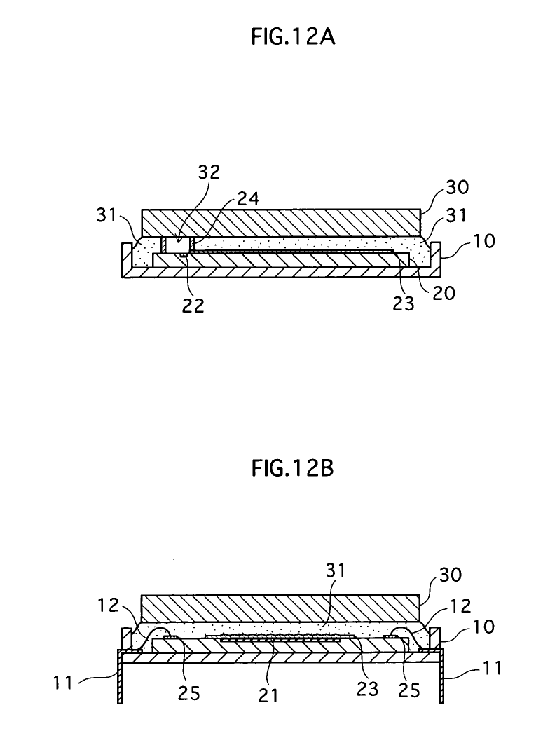

FIGS. 12A and 12B are cross-sectional views of the solid-state imaging apparatus of the second embodiment.

FIG. 12A shows an E-E′ cross-section in the planar view of FIG. 11, and FIG. 12B shows an F-F′ cross-section in the planar view of FIG. 11.

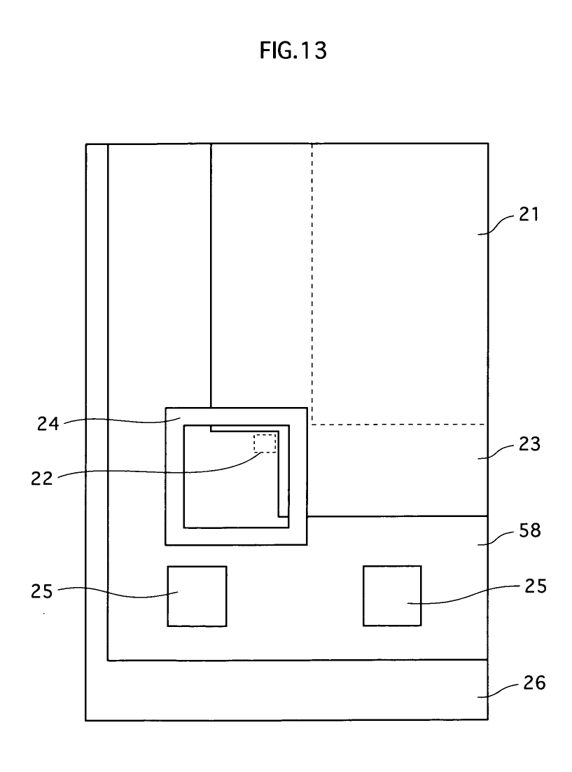

FIG. 13 is an enlarged planar view of the semiconductor substrate 20 of the second embodiment.

In the second embodiment, the dam member 24 surrounds the area corresponding to the floating diffusion region 22 on the semiconductor substrate 20. The translucent plate 30 is attached to the dam member 24 in a state of contacting the upper surface of the dam member 24. The gap 32 is formed in the area surrounded by the dam member 24.

Since the dam member 24 is formed so as to surround the area corresponding to the floating diffusion region 22 in the second embodiment, the translucent adhesive 31 applied to the area corresponding to the light receiving region 21 on the semiconductor substrate 20 is prevented from flowing into the area corresponding to the floating diffusion region 22 when attaching the translucent plate 30 to the semiconductor substrate 20. This means that the sensitivity of the solid-state imaging apparatus can be improved.

Note that the second embodiment is preferably used in cases in which the size of the semiconductor substrate 20 and the package substrate 10 is substantially the same, and cases in which the distance from the edge of the semiconductor substrate 20 to the edge of the package substrate 10 is within 200 μm.

### Third Embodiment

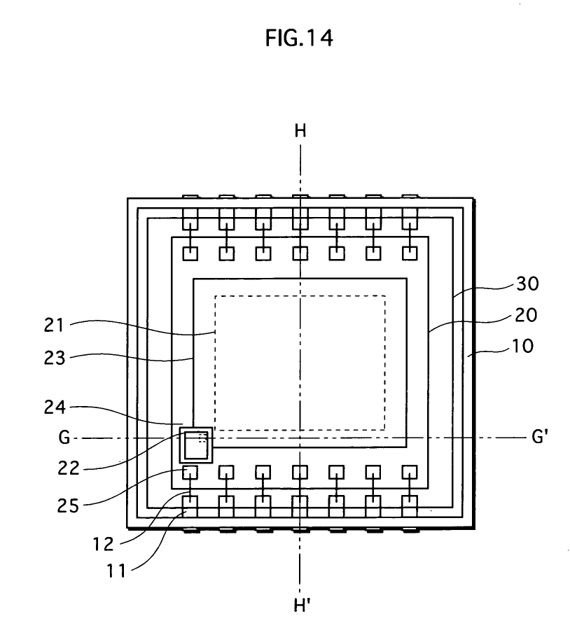

FIG. 14 is a planar view of a solid-state imaging apparatus of the third embodiment.

In the third embodiment the dam member 24 surrounds the area corresponding to the floating diffusion region 22 on the semiconductor substrate 20, and does not surround the electrodes 25 and the area corresponding to the light receiving region 21 on the semiconductor substrate 20. The package substrate 10 in the third embodiment is smaller than the package substrate 10 in the first embodiment, and larger than the package substrate 10 in the second embodiment.

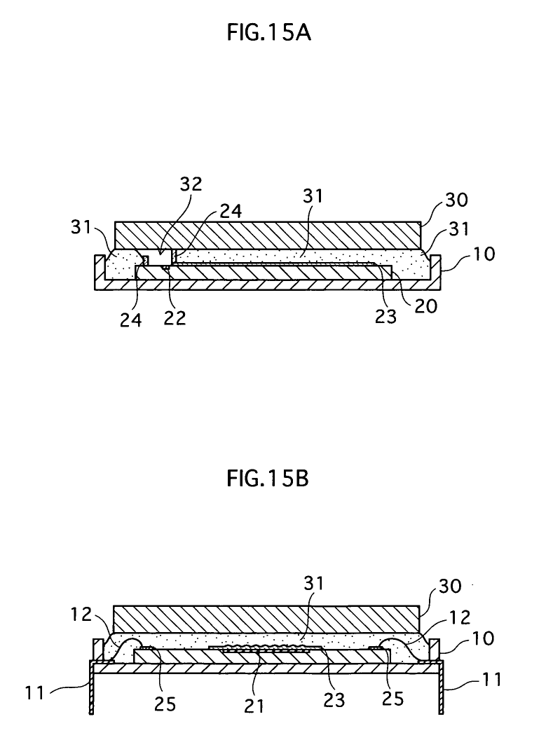

FIGS. 15A and 15B are cross-sectional views of the solid-state imaging apparatus of the third embodiment.

FIG. 15A shows a G-G′ cross-section in the planar view of FIG. 14, and FIG. 15B shows a H-H′ cross-section in the planar view of FIG. 14.

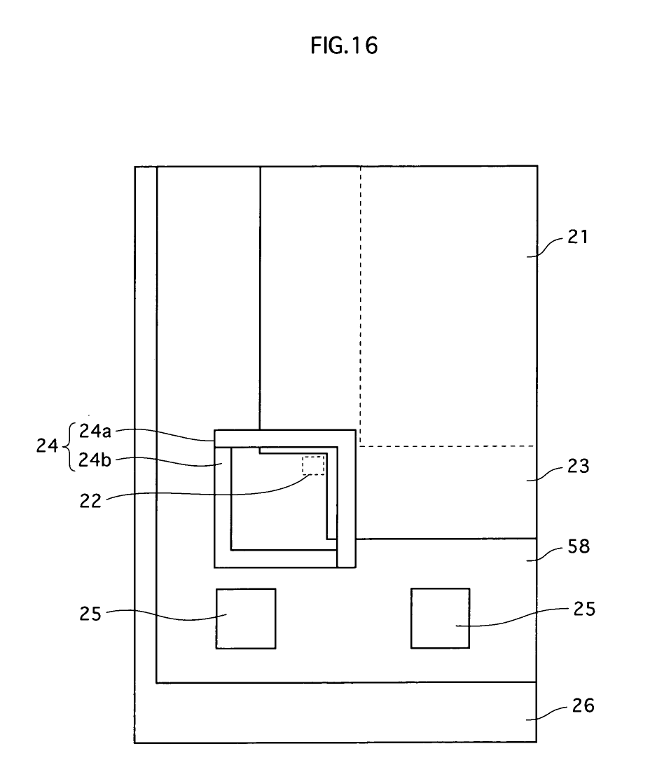

FIG. 16 is an enlarged planar view of the semiconductor substrate 20 of the third embodiment.

In the third embodiment, the dam member 24 surrounds the area corresponding to the floating diffusion region 22 on the semiconductor substrate 20. As shown in FIG. 16, the dam member 24 consists of two sites 24a and 24b that have respectively different heights. The translucent plate 30 is attached to the dam member 24 in a state of contacting a part of the upper surface of the site 24a (the site 24a). The gap 32 is formed in the area surrounded by the dam member 24.

In this way, since the translucent plate 30 contacts the site 24a of the dam member 24, and not the site 24b, the height of the site 24b does not have to be highly accurate. This enables manufacturing costs to be reduced.

Note that the third embodiment is preferably used in cases in which the distance from the edge of the semiconductor substrate 20 to the edge of the package substrate 10 is approximately 200 μm to 250 μm.

### Fourth Embodiment

<Structure>

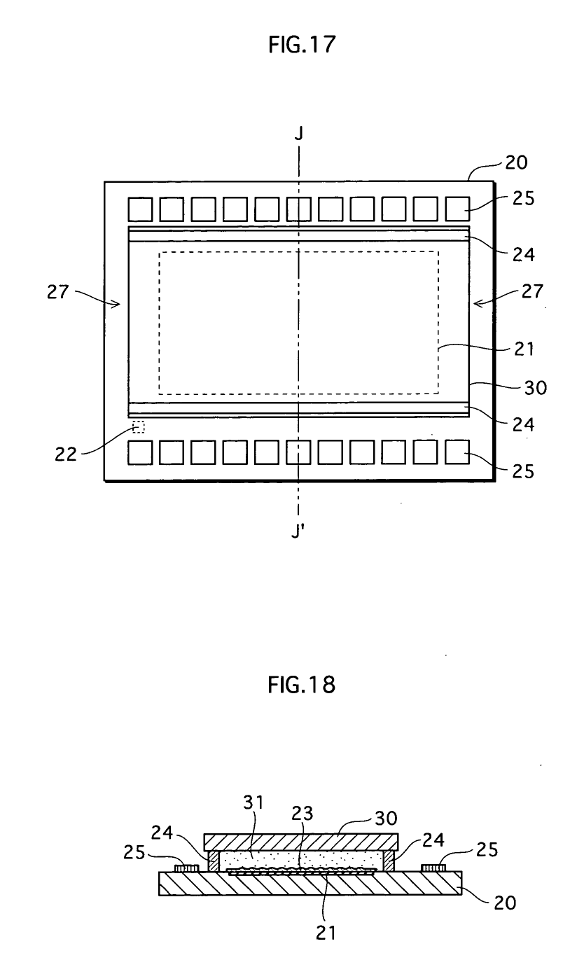

FIG. 17 is a planar view of a solid-state imaging apparatus of the fourth embodiment.

FIG. 18 is a cross-sectional view of the solid-state imaging apparatus of the fourth embodiment.

FIG. 18 shows a J-J′ cross-section in the planar view of FIG. 2.

In the fourth embodiment, the dam member 24 is formed in an area that is an outer peripheral area of the area corresponding to the light receiving region 21 on the semiconductor substrate 20 and an inner peripheral area of the area corresponding to the floating diffusion region 22 on the semiconductor substrate 20 and the areas in which the electrodes are formed. Furthermore, the dam member 24 has vents 27 in areas that are not between the area corresponding to the light receiving region 21 on the semiconductor substrate 20 and the area corresponding to the floating diffusion region 22 on the semiconductor substrate 20, and that are not between the electrodes 25 and the area corresponding to the light receiving region 21 on the semiconductor substrate 20.

According to this structure, since gas escapes through the vents 27 when attaching the translucent plate 30, bubbles do not occur in the area corresponding to the light receiving region 21. Furthermore, since the vents 27 exist in areas that are not between the area corresponding to the light receiving region 21 on the semiconductor substrate 20 and the area corresponding to the floating diffusion region 22 on the semiconductor substrate 20, and that are not between the electrodes 25 and the area corresponding to the light receiving region 21 on the semiconductor substrate 20, any translucent adhesive 31 that flows through the vents 27 can be prevented from reaching the electrodes 25 and the area corresponding to the floating diffusion region 22.

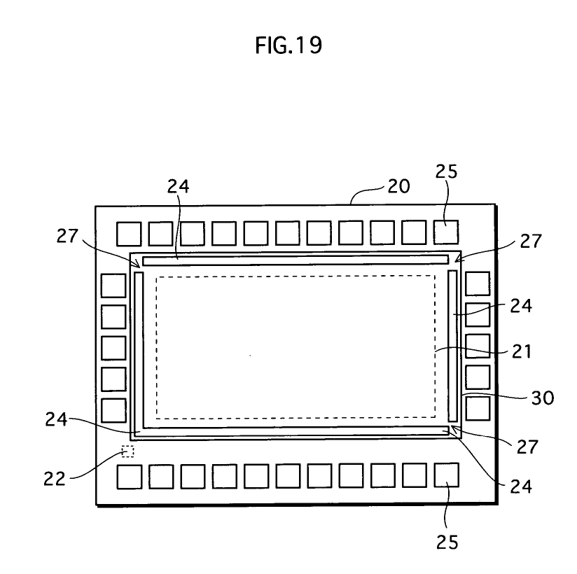

FIG. 19 is a planar view of a solid-state imaging apparatus relating to a modification example.

As shown in FIG. 19, the electrodes 25 are arranged along a periphery of the semiconductor substrate 20. In this example also, the dam member 24 has vents 27 in areas that are not between the area corresponding to the light receiving region 21 on the semiconductor substrate 20 and the area corresponding to the floating diffusion region 22 on the semiconductor substrate 20, and that are not between the electrodes 25 and the area corresponding to the light receiving region 21 on the semiconductor substrate 20. Therefore, the same effects as those described above can be achieved.

<Manufacturing Method>

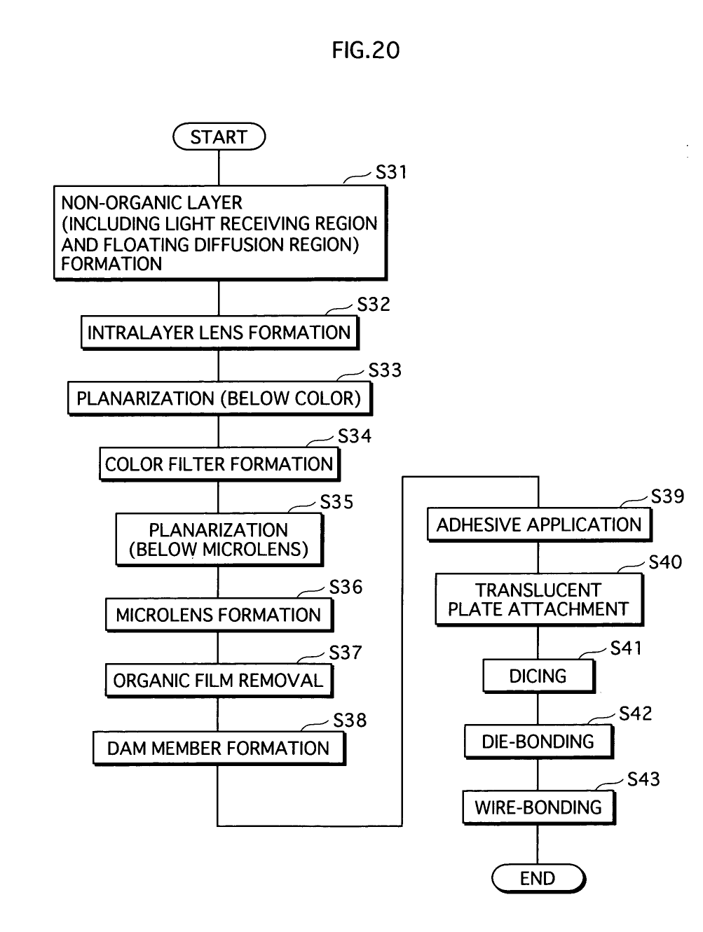

FIG. 20 shows the manufacturing process of the solid-state imaging apparatus of the fourth embodiment.

In the fourth embodiment, the adhesive application process (FIG. 20: S39) and the translucent plate attachment process (FIG. 20: S40) are performed before the dicing process (FIG. 20: S41), the die-bonding process (FIG. 20: S42) and the wire boding process (FIG. 20: S43). Attaching the translucent plate 30 in this way at an early stage further helps to protect the semiconductor substrate 20 from moisture, dust and the like. Note that details of each process are as described in FIG. 1, and therefore a description thereof is omitted here.

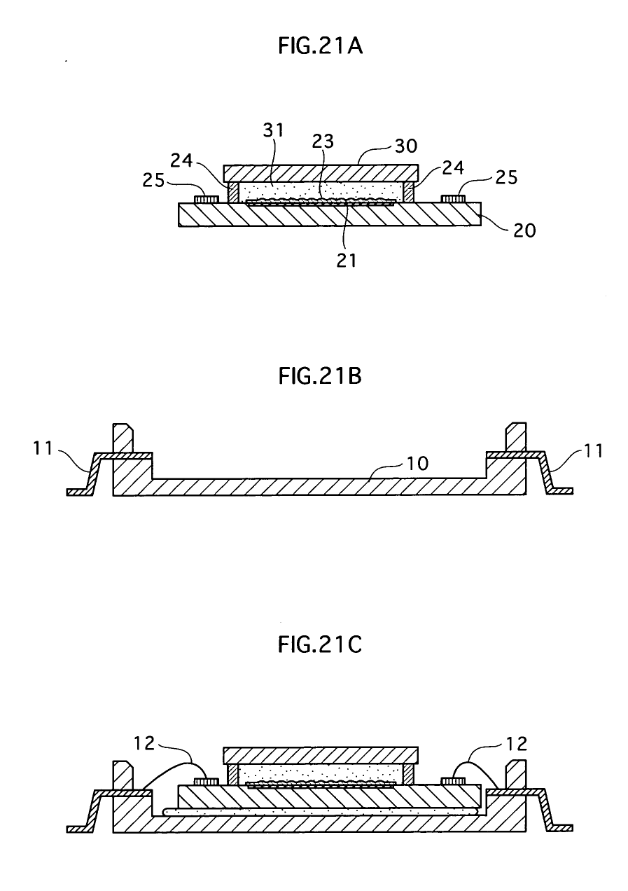

FIGS. 21A to 21C are process cross-sectional views of the solid-state imaging apparatus of the fourth embodiment.

FIG. 21A shows the semiconductor substrate diced by the dicing process. FIG. 21B shows the package substrate 10 prepared in the die-bonding process. FIG. 21C shows the solid-state imaging apparatus obtained after carrying out the die-bonding processing and the wire-bonding process.

### Fifth Embodiment

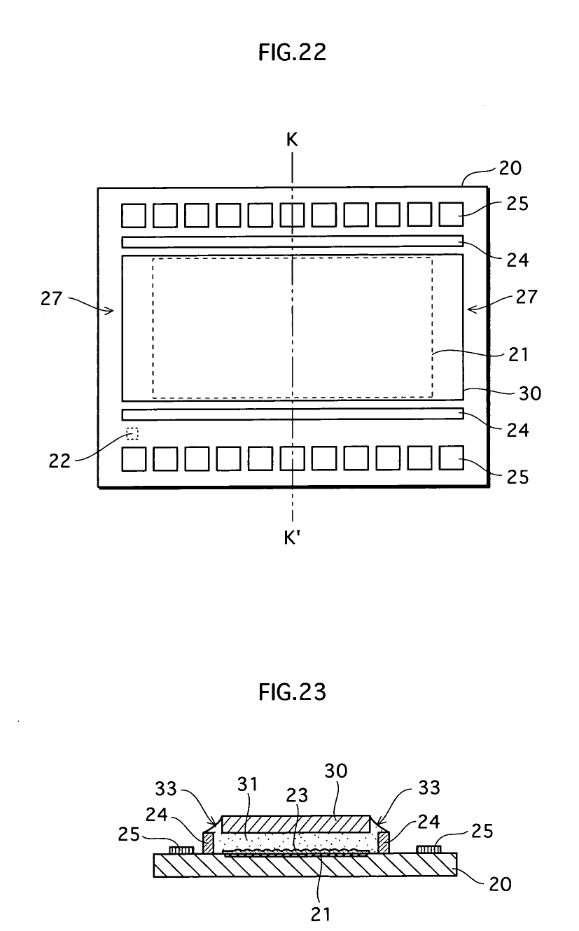

FIG. 22 is a planar view of a solid-state imaging apparatus of the fifth embodiment.

FIG. 23 is a cross-sectional view of the solid-state imaging apparatus of the fifth embodiment.

FIG. 23 shows a K-K′ cross-section in the planar view of FIG. 22. In the fifth embodiment, the translucent plate 30 is attached to the semiconductor substrate 20 in a state of not contacting the upper surface of the dam member 24, and fillets 33 of the translucent adhesive 31 are formed on the side faces of the translucent plate 30. Since the translucent plate 30 does not contact the top surface of the dam member 24, any gaps that occur between the translucent plate 30 and the translucent adhesive 31 when attaching the translucent plate 30 can be eliminated by pressing the translucent plate 30. In addition, the formation of the fillets 33 improves the adhesiveness of the translucent plate 30.

### Sixth Embodiment

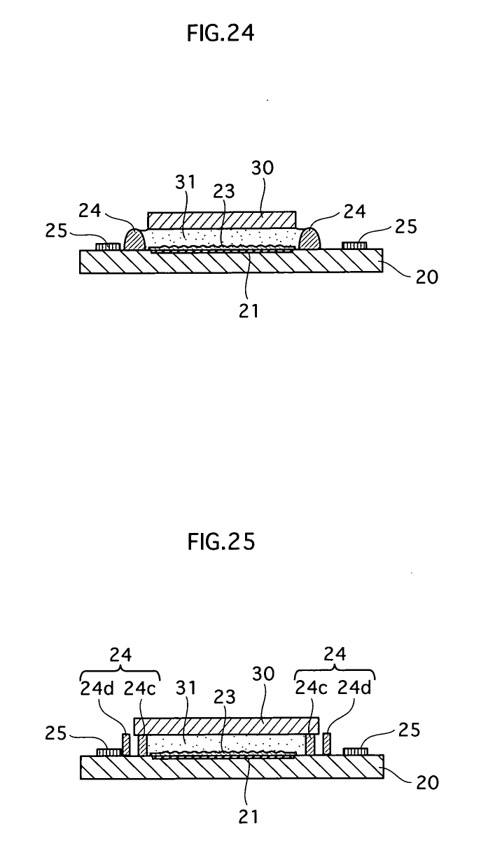

FIG. 24 is a cross-sectional view of a solid-state imaging apparatus of the sixth embodiment.

In the sixth embodiment, the upper surface of the dam member 24 curves in an upward convex. This allows for changes in shape due to heat contraction when forming the dam member 24, and therefore enables the dam member 24 to be formed more easily, as well as widening the selection of materials that can be used for the dam member 24.

### Seventh Embodiment

FIG. 25 is a cross-sectional view of the solid-state imaging apparatus of the seventh embodiment.

In the seventh embodiment, the dam member 24 has a dual structure consisting of an inner dam 24c and an outer dam 24d. This structure enables any translucent adhesive 31 that flows over the inner dam 24c when attaching the translucent plate 30 to be stemmed by the outer dam 24d.

### Eighth Embodiment

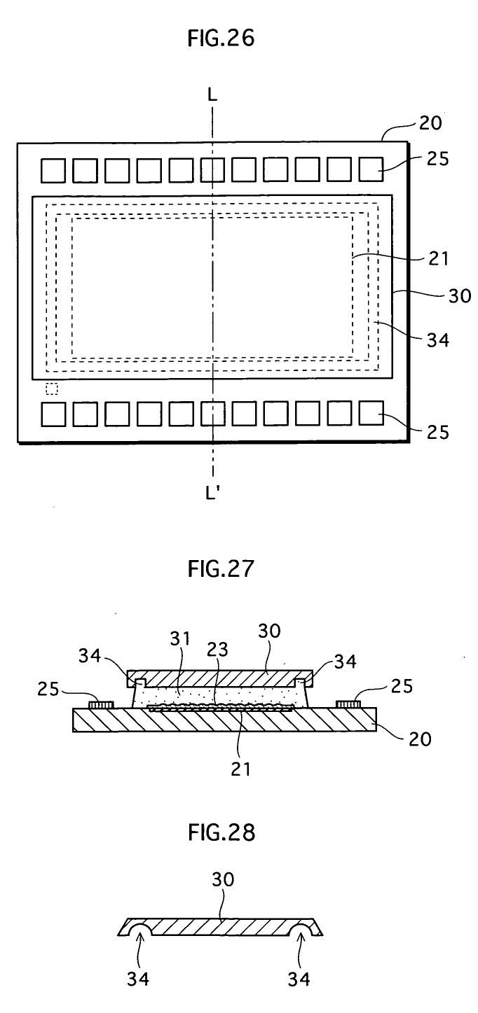

FIG. 26 is a planar view of the solid-state imaging apparatus of the eighth embodiment.

FIG. 27 is a cross-sectional view of the solid-state imaging apparatus of the eighth embodiment.

FIG. 27 shows an L-L′ cross-section in the planar view of FIG. 26.

In the eighth embodiment, the translucent plate 30 has grooves 34 in areas other than the area facing the light receiving region 21, these grooves 34 being formed in the surface that is attached to the semiconductor substrate 20. The grooves 34 receive part of the translucent adhesive 31 applied to the area corresponding to the light receiving region 21 on the semiconductor substrate 20. If the grooves 34 are provided in this way, excess translucent adhesive 31 is received by the grooves 34 when attaching the translucent plate 30 to the semiconductor substrate 20. This enables a direct laying structure by which the translucent plate 30 and the semiconductor substrate 20 are attached to each other by the translucent adhesive 31, while also preventing the translucent adhesive 31 from adhering to the electrodes 25.

Furthermore, since the grooves 34 are disposed in a direction in which the electrodes 25 are arranged, the translucent adhesive 31 can be even more effectively prevented from adhering to the electrodes 25.

Note that although the grooves 34 have a rectangular cross-sectional shape in the present example, they are not limited to this shape, and may instead have curved cross-sectional shape as shown in FIG. 28.

Although the solid-state imaging apparatus of the present invention has been described based on the above preferred embodiments, the present invention is not limited to these preferred embodiments. The following are examples of possible modifications.

(1) In the first embodiment, the dam member 24 extends from the first edge of the semiconductor substrate 20 to the second edge of the semiconductor substrate 20. However, the dam member 24 is not limited to this structure as long as it is formed at least in a position between the light receiving region 21 and the floating diffusion region 22 on the semiconductor substrate 20. For instance, instead of extending completely to the edges of the semiconductor substrate 20, the dam member 24 may stop part way towards the edges. How far the dam member 24 extends is determined with an object of preventing the translucent adhesive 31 from flowing to the floating diffusion region 22, based on the viscosity and application amount of the translucent adhesive 31, the position and height of the dam member 24, and the mutual positional relationship with the light receiving region 21 and the floating diffusion region 22.

(2) In the first embodiment, although the dam member 24 is formed after the layers that constitute the organic film 23 (layers 61 to 65) are formed, the dam member 24 may be formed at any stage. However, it is preferable to form the dam member 24 after the layers that constitute the organic film 23 as in the first embodiment if spin-coating is used to form the layers that constitute the organic film 23.

(3) In the first embodiment, the planar shape of the dam member 24 is a shape having a substantially right-angular bend, and in the second embodiment and the third embodiment the planar shape of the dam member 24 is a square shape. However, the planar shape of the dam member 24 is not limited to any particular shape as long as the dam member 24 can prevent the translucent adhesive 31 from flowing to the floating diffusion region 22. For instance, the planar shape of the dam member 24 may be a round shape or a polygonal shape. Furthermore, the planar shape of the dam member 24 may be a combination of the shape in the first embodiment and the shape in the second embodiment.

(4) The cross-sectional shape of the dam member 24 is not limited to being a rectangular shape as shown in the preferred embodiments, examples of other possible shapes being a trapezoidal shape and an inverted trapezoidal shape.

(5) In any of the embodiments, the dam member 24 may be used together with a dummy pattern formed for another purpose. For instance, the dam member 24 may be together with a dummy pattern for forming an even thin film on the microlens.

Although the present invention has been fully described by way of examples with reference to the accompanying drawings, it is to be noted that various changes and modification will be apparent to those skilled in the art. Therefore, unless otherwise such changes and modifications depart from the scope of the present invention, they should be construed as being included therein.

What is claimed is:

1. A manufacturing method for a solid-state imaging apparatus, comprising:
a formation process of forming a light receiving region and a floating diffusion region apart from each other in a semiconductor substrate;
an applying process of applying translucent adhesive to the semiconductor substrate, in an area thereon corresponding to the light receiving region; and
an attachment process of attaching a translucent plate to the semiconductor substrate with use of the translucent adhesive applied in the applying process,
wherein, furthermore in the formation process, a dam member is formed on the semiconductor substrate such that the translucent adhesive applied in the area corresponding to the light receiving region is prevented from flowing into an area corresponding to the floating diffusion region on the semiconductor substrate.

2. The manufacturing method of claim 1, wherein
the dam member is formed so as to extend from a first edge of the semiconductor substrate to a second edge of the semiconductor substrate, and so as to partition the area corresponding to the light receiving region from the area corresponding to the floating diffusion region.

3. The manufacturing method of claim 1, wherein
the dam member is formed so as to surround the area corresponding to the floating diffusion region, without surrounding the area corresponding to the light receiving region.

4. The manufacturing method of claim 1, wherein
in the formation process, the dam member is formed such that a height thereof is a predetermined height, and
in the attachment process, the translucent plate is attached to the semiconductor substrate by placing the translucent plate on the translucent adhesive that has been applied to the area corresponding to the light receiving region, pressing the placed translucent plate until the translucent plate contacts an upper surface of the dam member while the translucent adhesive maintains fluidity, and hardening the translucent adhesive.

5. The manufacturing method of claim 1, wherein
a horizontal cross-section of the dam member has a rectangular shape or a tapered shape.

6. The manufacturing method of claim 1, wherein
in the formation process, the dam member is formed by applying a photosensitive material to the semiconductor substrate, and, using a photolithography technique with respect to the applied photosensitive material, hardening apart thereof that is to be the dam member and removing the photosensitive material other than the part thereof that is to be the dam member.

7. The manufacturing method of claim 1, wherein
in the formation process, the dam member is formed by depositing an etchable material on the semiconductor substrate, and, using an etching technique with respect to the deposited etchable material, causing a part of thereof that is to be the dam member to remain on the semiconductor substrate and removing the deposited material other than the part thereof that is to be the dam member.

8. A manufacturing method for a solid-state imaging apparatus, comprising:
a formation process of forming a light receiving region in a semiconductor substrate and forming a plurality of electrodes on the semiconductor substrate, the plurality of electrodes being apart on the semiconductor substrate from an area thereon corresponding to the light receiving region;
an applying process of applying translucent adhesive to the area corresponding to the light receiving region; and
an attachment process of attaching a translucent plate to the semiconductor substrate with use of the translucent adhesive applied in the applying process,
wherein, furthermore in the formation process, a dam member is formed on the semiconductor substrate such that the translucent adhesive applied in the area corresponding to the light receiving region is prevented from flowing to the electrodes.

9. The manufacturing method of claim 8, wherein
the dam member is formed in an area that is an outer peripheral area of the area corresponding to the light receiving region and an inner peripheral area of an area in which the electrodes are formed.

10. The manufacturing method of claim 9, wherein
the dam member has a vent in an area other than an area between the plurality of electrodes and the area corresponding to the light receiving region.

11. The manufacturing method of claim 8, wherein
in the formation process, the dam member is formed such that a height thereof is a predetermined height, and
in the attachment process, the translucent plate is attached to the semiconductor substrate by placing the translucent plate on the translucent adhesive that has been applied to the area corresponding to the light receiving region, pressing the placed translucent plate until the translucent plate contacts an upper surface of the dam member while the translucent adhesive maintains fluidity, and hardening the translucent adhesive.

12. The manufacturing method of claim 8, wherein
a horizontal cross-section of the dam member has a rectangular shape or a tapered shape.

13. The manufacturing method of claim 8, wherein
in the formation process, the dam member is formed by applying a photosensitive material to the semiconductor substrate, and, using a photolithography technique with respect to the applied photosensitive material, hardening a part thereof that is to be the dam member and removing the photosensitive material other than the part thereof that is to be the dam member.

14. The manufacturing method of claim 8, wherein
in the formation process, the dam member is formed by depositing an etchable material on the semiconductor substrate, and, using an etching technique with respect to the deposited etchable material, causing a part of thereof that is to be the dam member to remain on the semiconductor substrate and removing the deposited material other than the part thereof that is to be the dam member.

15. A solid-state imaging apparatus comprising:
a semiconductor substrate having disposed therein a light receiving region and a floating diffusion region that are apart from each other;
a translucent plate that is attached to the semiconductor substrate via translucent adhesive that has been applied to the semiconductor substrate in an area thereon corresponding to the light receiving region; and
a dam member disposed on the semiconductor substrate such that the translucent adhesive applied in the area corresponding to the light receiving region is prevented from flowing into an area corresponding to the floating diffusion region on the semiconductor substrate.

16. The solid-state imaging apparatus of claim 15, wherein
the dam member is made of resin that contains filler.

17. A solid-state imaging apparatus comprising:
a semiconductor substrate that has a light receiving region therein;
a plurality of electrodes disposed on the semiconductor substrate, the plurality of electrodes being apart on the semiconductor substrate from an area thereon corresponding to the light receiving region;
a translucent plate attached to the semiconductor substrate with use of translucent adhesive that has been applied to the semiconductor substrate in the area corresponding to the light receiving region; and
a dam member disposed on the semiconductor substrate such that the translucent adhesive applied in the area corresponding to the light receiving region is prevented from flowing to the electrodes.

18. The solid-state imaging apparatus of claim 17, wherein
the dam member is disposed in an area that is an outer peripheral area of the area corresponding to the light receiving region and an inner peripheral area of an area in which the electrodes are formed.

19. The solid-state imaging apparatus of claim 17, wherein
a fillet is formed from the translucent adhesive at a side face of the translucent plate.

20. The solid-state imaging apparatus of claim 17, wherein
a horizontal cross-section of the dam member has a rectangular shape or a tapered shape.

21. The solid-state imaging apparatus of claim 17, wherein
an upper surface of the dam member curves in an upward convex.

22. The solid-state imaging apparatus of claim 17, wherein
the dam member is made of organic resin.

23. The solid state imaging apparatus of claim 22, wherein
the dam member is made of photosensitive material.

24. A solid-state imaging apparatus comprising:
a semiconductor substrate that has a light receiving region therein;
a plurality of electrodes disposed on the semiconductor substrate, the plurality of electrodes being apart on the semiconductor substrate from and area thereon corresponding to the light receiving region; and
a translucent plate attached to the semiconductor substrate via translucent adhesive that has been applied to the semiconductor substrate in the area corresponding to the light receiving region,
wherein the translucent plate has a groove in a surface that is attached to the semiconductor substrate, the groove being in an area of the surface other than an area that opposes the light receiving region, and part of the translucent adhesive applied to the area corresponding to the light receiving region is received by the groove.

25. The solid-state imaging apparatus of claim 24, wherein
the plurality of electrodes are disposed in a row, and
the groove extends in a direction in which the electrodes are arranged.
